(19) United States
(12) Patent Application Publication
(10) Pub. No.: US 2020/0379289 A1
(43) Pub. Date: Dec. 3, 2020

(54) BACKLIGHT MODULE AND LIQUID CRYSTAL MODULE

(71) Applicant: WUHAN CHINA STAR OPTOELECTRONICS TECHNOLOGY CO., LTD., Wuhan, Hubei (CN)

(72) Inventor: Zheng ZHOU, Wuhan, Hubei (CN)

(21) Appl. No.: 16/631,173

(22) PCT Filed: Sep. 23, 2019
(86) PCT No.: PCT/CN2019/107312

§ 371 Date: Jan. 15, 2020

(30) Foreign Application Priority Data
May 27, 2019 (CN) 201910446471.8

(51) Int. Cl. G02F 1/1333; G02F 1/13357

(52) U.S. Cl. CPC G02F 1/133308; G02F 2001/133314; G02F 1/133615; G02F 1/133608

(57) ABSTRACT

A backlight module and a liquid crystal module are provided. At least one of side walls of a back plate in the backlight module is provided with an avoidance gap at a location corresponding to an optical film. A height of the avoidance gap is greater than or equal to a thickness of the optical film. By disposing the avoidance gap at the location of the side wall corresponding to the optical film, when the optical film is thermally expanded, the deformed optical film is located within the avoidance gap, and thus the optical film does not generate wrinkles caused by the expansion being impeded.

### FIELD OF INVENTION

The present disclosure relates to the field of display technology, and in particular, to a backlight module and a liquid crystal module.

### BACKGROUND OF INVENTION

As shown in FIG. 1, in a backlight module 10 of a conventional in-vehicle display device, sheet metal parts, such as cast aluminum parts, are generally used for a back plate 101. The back plate 101 includes a bottom plate 1011 and side walls 1012, and the bottom plate 1011 and the side walls 1012 form a receiving cavity a. A light source 102, a light-guiding plate 103, and an optical film layer 104 are disposed within the receiving cavity a. A fixed frame 105 is fixed on the back plate 101. In order to realize a narrow frame of the in-vehicle display device, a gap s between the optical film 104 and the side walls 1012 is small.

Under a high temperature condition, the optical film may be expanded. Because the entire optical film of the in-vehicle display device is large, deformation amount caused by the expansion is also large. When the deformation amount of the optical film is greater than the gap between the optical film and the side walls, the optical film may be wrinkled due to the expansion being impeded, thereby resulting in poor optical performance of the backlight module.

Therefore, the conventional backlight modules used in the in-vehicle display devices with the narrow frames have a technical problem about the expansion of the optical films being impeded, and the technical problem needs to be improved.

### SUMMARY OF INVENTION

The present disclosure provides a backlight module and a liquid crystal module to ameliorate a technical problem about expansion of optical films being impeded, which is existed in conventional backlight modules used in in-vehicle display devices with the narrow frames.

In order to solve the above-mentioned problem, technical solutions provided by the present disclosure as follows:

Embodiments of the present disclosure provide a backlight module, and the backlight module includes:

a back plate including a bottom plate and side walls, wherein the bottom plate and the side walls form a receiving cavity;

a light source disposed within the receiving cavity;

a light-guiding member disposed within the receiving cavity, wherein a light-out surface of the light source corresponds to a light-in surface of the light-guiding member;

an optical film disposed within the receiving cavity and located on the light-out surface of the light-guiding member; and

a fixed frame disposed on the side walls;

wherein at least one of the side walls is provided with an avoidance gap and supporting protrusions located at both sides of the avoidance gap, a disposed location of the avoidance gap corresponds to a site of the optical film, a height of the avoidance gap is greater than or equal to a thickness of the optical film, and the fixed frame are disposed on the supporting protrusions.

In the backlight module provided by the embodiments of the present disclosure, a width of the avoidance gap is greater than a width of the optical film.

In the backlight module provided by the embodiments of the present disclosure, a width of the avoidance gap is less than a width of the optical film, the optical film is provided with film gaps at regions corresponding to the supporting protrusions, and the difference between the width of the optical film and a total width of the film gaps is less than the width of the avoidance gap.

In the backlight module provided by the embodiments of the present disclosure, the light source is disposed between the light-guiding plate and at least one of the side walls, or the light source is disposed between the light-guiding plate and the bottom plate.

In the backlight module provided by the embodiments of the present disclosure, the avoidance gap is shaped as a recess.

In the backlight module provided by the embodiments of the present disclosure, the backlight module further includes a reflection sheet disposed within the receiving cavity and located between the light-guiding member and the bottom plate.

In the backlight module provided by the embodiments of the present disclosure, the fixed frame includes at least one of a plastic frame, a cast aluminum part, or a sheet metal frame.

In the backlight module provided by the embodiments of the present disclosure, a bottom surface of the fixed frame is provided with fixed gaps, and the fixed frame is fixed on the side walls by the fixed gaps and the supporting protrusions.

In the backlight module provided by the embodiments of the present disclosure, a cross-sectional shape of the fixed gaps is at least one of a rectangle, a trapezoid, or a semicircle

In the backlight module provided by the embodiments of the present disclosure, a height of the supporting protrusions is greater than or equal to a depth of the fixed gaps.

The embodiments of the present disclosure provide a liquid crystal module, and the liquid crystal module includes:

a backlight module including a back plate, a light source, a light-guiding plate, an optical film, and a fixed frame, wherein the back plate includes a bottom plate and side walls, and the bottom plate and the side walls form a receiving cavity; the light source, the light-guiding plate, and the optical film are disposed within the receiving cavity, a light-out surface of the light source corresponds to a light-in surface of the light-guiding plate, and the optical film is located on the light-out surface of the light-guiding plate; the fixed frame is disposed on the back plate; and

a liquid crystal display panel fixed on the fixed frame;

wherein at least one of the side walls is provided with an avoidance gap and supporting protrusions located at both sides of the avoidance gap, a disposed location of the avoidance gap corresponds to a site of the optical film, a height of the avoidance gap is greater than or equal to a thickness of the optical film, and the fixed frame are disposed on the supporting protrusions.

In the liquid crystal module provided by the embodiments of the present disclosure, the liquid crystal module further includes a touch panel fixed on the fixed frame.

In the liquid crystal module provided by the embodiments of the present disclosure, a width of the avoidance gap is greater than a width of the optical film, or the width of the avoidance gap is less than the width of the optical film; the optical film is provided with film gaps at regions corresponding to the supporting protrusions, and the difference between the width of the optical film and a total width of the film gaps is less than the width of the avoidance gap.

In the liquid crystal module provided by the embodiments of the present disclosure, the light source is disposed between the light-guiding plate and at least one of the side walls, or the light source is disposed between the light-guiding plate and the bottom plate.

In the liquid crystal module provided by the embodiments of the present disclosure, the avoidance gap is shaped as a recess.

In the liquid crystal module provided by the embodiments of the present disclosure, the liquid crystal module further includes a reflection sheet disposed within the receiving cavity and located between the light-guiding member and the bottom plate.

In the liquid crystal module provided by the embodiments of the present disclosure, the fixed frame includes at least one of a plastic frame, a cast aluminum part, or a sheet metal frame.

In the liquid crystal module provided by the embodiments of the present disclosure, a bottom surface of the fixed frame is provided with fixed gaps, and the fixed frame is fixed on the side walls by the fixed gaps and the supporting protrusions.

In the liquid crystal module provided by the embodiments of the present disclosure, a cross-sectional shape of the fixed gaps is at least one of a rectangle, a trapezoid, or a semicircle.

In the liquid crystal module provided by the embodiments of the present disclosure, a height of the supporting protrusions is greater than or equal to a depth of the fixed gaps.

### Advantageous Effects of the Present Disclosure

The present disclosure provides a backlight module and a liquid crystal module. The backlight module includes the back plate, the light source, the light-guiding member, the optical film, and the fixed frame. The back plate includes the bottom plate and the side walls, and the bottom plate and the side walls form the receiving cavity. The light source is disposed within the receiving cavity, the light-guiding member is disposed within the receiving cavity, and the light-out surface of the light source corresponds to the light-in surface of the light-guiding member. The optical film is disposed within the receiving cavity and located on the light-out surface of the light-guiding member. The fixed frame is disposed on the back plate. At least one of the side walls is provided with the avoidance gap at the location corresponding to the optical film, and the height of the avoidance gap is greater than or equal to the thickness of the optical film. In the embodiments of the present disclosure, by disposing the avoidance gap at the location of the side wall corresponding to the optical film, when the optical film is thermally expanded, the deformed optical film is located within the avoidance gap, so the side wall does not impede the expansion of the optical film, such that the optical film does not generate wrinkles caused by the expansion being impeded, thereby ameliorating the technical problem about the expansion of the optical films being impeded, which is existed in the conventional backlight modules used in the in-vehicle display devices with the narrow frames, enhancing display stability of the in-vehicle display devices with the narrow frames, and improving users' experiences.

### DESCRIPTION OF DRAWINGS

In order to clearly illustrate technical solutions in embodiments of the present disclosure, the drawings required for using in the description of the embodiments or the prior art is briefly described below. Obviously, the drawings in the following description are only some of the embodiments of the present disclosure. For those skilled in the art, other drawings may also be obtained in accordance with these drawings without making for creative efforts.

FIG. 1 is a structural schematic view of a backlight module in prior art.

FIG. 2 is a schematic view of a first structure of a backlight module provided by embodiments of the present disclosure.

FIG. 3 is a first cross-sectional schematic view of a cross-section A-A′ in FIG. 2.

FIG. 4 is a second cross-sectional schematic view of the cross-section A-A′ in FIG. 2.

FIG. 5 is a third cross-sectional schematic view of the cross-section A-A′ in FIG. 2.

FIG. 6 is a first cross-sectional schematic view of a cross-section B-B′ in FIG. 2.

FIG. 7 is a second cross-sectional schematic view of the cross-section B-B′ in FIG. 2.

FIG. 8 is a schematic view of a second structure of the backlight module provided by embodiments of the present disclosure.

FIG. 9 is a schematic view of a first structure of a liquid crystal module provided by the embodiments of the present disclosure.

FIG. 10 is a schematic view of a second structure of the liquid crystal module provided by the embodiments of the present disclosure.

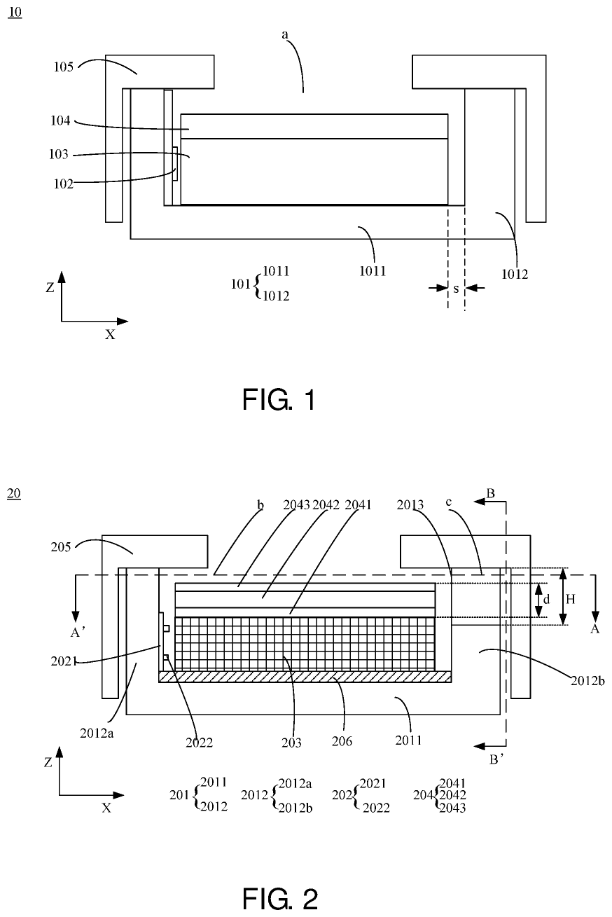

### DETAILED DESCRIPTION OF PREFERRED EMBODIMENTS

Directional terms mentioned by the present disclosure, such as “upper”, “lower”, “front”, “back”, “left”, “right”, “inner”, “outer”, “side”, etc., are only directions by referring to the accompanying drawings. Therefore, the used directional terms are applied to illustrate and understand the present disclosure, but not to limited the present disclosure. In the drawings, units with similar structures are denoted by the same reference numerals.

In the drawings of the disclosure, X represents a direction of length of modules, Y represents a direction of width of the modules, and Z represents a direction of height of the modules.

For a technical problem about expansion of optical films being impeded, which is existed in conventional backlight modules used in in-vehicle display devices, the embodiments of the present disclosure may ameliorate the technical problem.

In an embodiment, as shown in FIG. 2 to FIG. 8, a backlight module 20 provided by the embodiment of the present disclosure includes:

a back plate 201 including a bottom plate 2011 and side walls 2012, wherein the bottom plate 2011 and the side walls 2012 form a receiving cavity b;

a light source 202 disposed within the receiving cavity b;

a light-guiding member 203 disposed within the receiving cavity b, wherein a light-out surface of the light source 202 corresponds to a light-in surface of the light-guiding member 203;

an optical film 204 disposed within the receiving cavity b and located on the light-out surface of the light-guiding member 203; and

a fixed frame 205 disposed on the side walls 2012;

wherein at least one of the side walls 2012 is provided with an avoidance gap c and supporting protrusions 2013 located at both sides of the avoidance gap c, a disposed location of the avoidance gap c corresponds to a site of the optical film 204, a height H of the avoidance gap c is greater than or equal to a thickness d of the optical film 204, and the fixed frame 205 is disposed on the supporting protrusions 2013.

In the embodiment, under a high temperature condition, the optical film 204 is expanded along the X direction. Based on the avoidance gap c, the side walls 2012 does not block the optical film 204, so the optical film 204 may extend into the avoidance gap c, such that the optical film does not generate wrinkles to prevent causing poor optical performance.

The embodiment provides a backlight module. The backlight module includes the back plate, the light source, the light-guiding member, the optical film, and the fixed frame. The backlight includes the bottom plate and the side walls, and the bottom plate and the side walls form the receiving cavity. The light source is disposed within the receiving cavity, the light-guiding member is disposed within the receiving cavity, and the light-out surface of the light source corresponds to the light-in surface of the light-guiding member. The optical film is disposed within the receiving cavity and located on the light-out surface of the light-guiding member. The fixed frame is disposed on the back plate. At least one of the side walls is provided with the avoidance gap at the location corresponding to the optical film, and the height of the avoidance gap is greater than or equal to the thickness of the optical film. In the embodiment, by disposing the avoidance gap at the location of the side wall corresponding to the optical film, when the optical film is thermally expanded, the deformed optical film is located within the avoidance gap, so the side wall does not impede the expansion of the optical film, such that the optical film does not generate the wrinkles caused by the expansion being impeded, thereby improving users' experiences.

In an embodiment, iron frames, sheet metal pieces, cast aluminum parts, etc. are generally employed by the back plate 201 to ensure strength and desirable heat dissipation performance.

In the embodiment shown in FIG. 2, the backlight module 20 is an edge-type backlight module. The light source 202 is disposed between the light-guiding member 203 and at least one of the side walls 2012. Typically, the light source 202 is only disposed between the light-guiding member 203 and at least one of the side walls 2012, but the light source 202 may also be disposed between the light-guiding member 203 and several side walls 2012. As shown in FIG. 2, the light source 202 includes a light bar 2021 and LED lights 2022 fixed on the light bar 2021, and the light bar 2021 is fixed on the side wall 2012a.

In the embodiment shown in FIG. 2, because the backlight module 20 is the edge-type backlight module, the light-guiding member 203 is a light-guiding plate. The light-guiding plate transforms edge-type horizontal incident light into vertical emergent light, and the vertical emergent light is emitted by the light-out surface of the light-guiding member 203. The light-guiding plate is generally composed of an optical grade resin material, and the commonly used optical grade resin materials are thermoplastic resin, polycarbonate, and acrylic.

In an embodiment, as shown FIG. 2, the backlight module 20 is further provided with a reflection sheet 206 under the light-guiding member 203. The reflection sheet 206 is disposed on the bottom plate 2011 of the back plate 201, and the light-guiding member 203 is disposed on the reflection sheet 206. Typically, material composing the reflection sheet 206 is a polyethylene terephthalate (PET) film whose surface is plated with a high reflectivity metal film, or a combination of upper and lower polyethylene terephthalate (PET) film layers containing a core layer (with high reflectivity polymer resin). A major function of the reflection sheet 206 is to reflect the light leaked from the light-guiding member 203 to improve utilization of the light source.

The optical film 204 includes a diffusion sheet 2041, a prism sheet 2042, and a reflective polarization enhancing film 2043, which are disposed in laminations. The diffusion sheet 2041 generally employs a polyethylene terephthalate (PET) or polycarbonate (PC) substrate with a smooth front surface and a rough reverse surface. A function of the diffusion sheet 2041 is to refract, reflect, and scatter the light emitted by the light-out surface of the light-guiding member 203 many times to render the backlight uniform. The prism sheet 2042 is a light-converging device, and the light-converging device concentrates the scattered light within a certain range of angles to emit by using law of total internal reflection and law of refraction, thereby enhancing brightness within the emitting range.

In an embodiment, the fixed frame 205 includes at least one of a plastic frame, a cast aluminum part, or a sheet metal frame. The plastic frame is formed by using polycarbonate or polycarbonate doped with glass fiber, the cast aluminum part is formed by using aluminum alloy, and the sheet metal frame is formed by using sheet metal, thereby ensuring supporting strength.

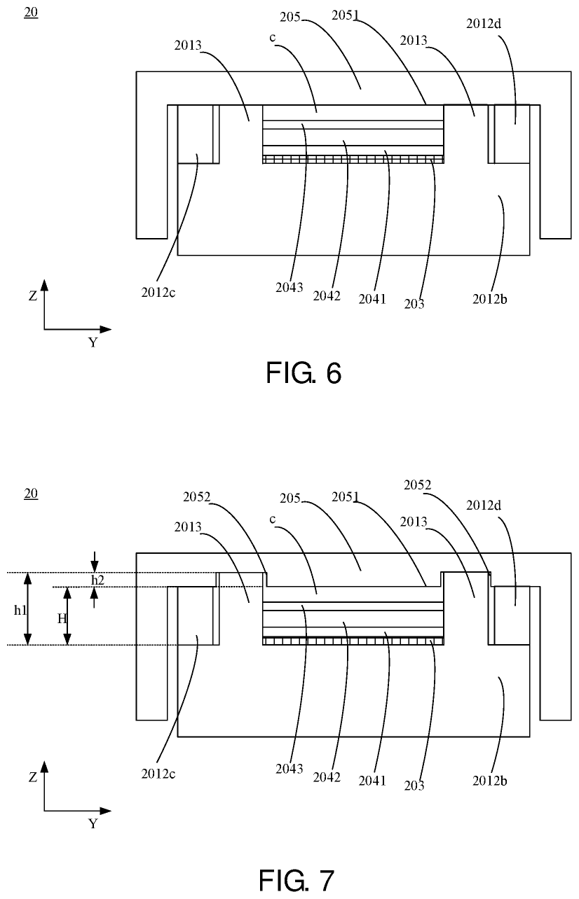

In an embodiment, as shown in FIG. 6, the fixed frame 205 includes a bottom surface 2051 disposed on the supporting protrusions 2013.

In the side walls of an embodiment, as shown in FIG. 6, the back plate 201 includes the side wall 2012a, the side wall 2012b, the side wall 2012c, and the side wall 2012d, the side wall 2012a and the side wall 2012b are oppositely arranged, and the side wall 2012c and the side wall 2012d are oppositely arranged.

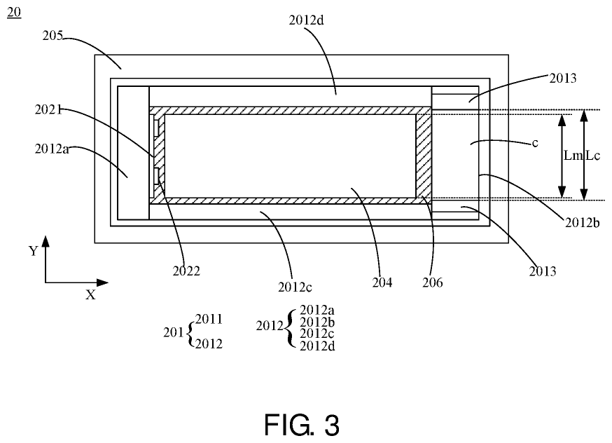

As shown in FIG. 2 and FIG. 3, the light source 202 is fixed on the side wall 2012a, and the avoidance gap c is disposed on the side wall 2012b.

In an embodiment, the avoidance gap c is disposed on two of the side walls being opposite to each other, such as the side wall 2012c and the side wall 2012d. When the optical film 204 is heated to expand toward the side wall 2012c and the side wall 2012d, both of the side walls based on the avoidance gap c does not impede the optical film, so the optical film 204 may extend to the two side walls and does not generate the wrinkles, thereby preventing causing the poor optical performance.

In an embodiment, the avoidance gap c is disposed on two of the side walls being adjacent to each other, such as the side wall 2012c and the side wall 2012b. When the optical film 204 is heated to expand toward the side wall 2012c and the side wall 2012b, both of the side walls based on the avoidance gap c does not impede the optical film, so the optical film 204 may extend to the two side walls and does not generate the wrinkles, thereby preventing causing the poor optical performance.

In an embodiment, the avoidance gap c is disposed on three of the side walls, such as the side wall 2012b, the side wall 2012c, and the side wall 2012d. When the optical film 204 is heated to expand toward the side wall 2012b, the side wall 2012c, and the side wall 2012d, the three side walls based on the avoidance gap c do not impede the optical film, so the optical film 204 may extend to the side walls and does not generate the wrinkles, thereby preventing causing the poor optical performance.

In an embodiment, the avoidance gap c is disposed on all of the side walls, such as the side wall 2012a, the side wall 2012b, the side wall 2012c, and the side wall 2012b. When the optical film 204 is heated to expand toward surroundings, the side walls based on the avoidance gap c do not impede the optical film, so the optical film 204 may extend to the side walls and does not generate the wrinkles, thereby preventing causing the poor optical performance.

In an embodiment, the light source 202 may also be disposed between the light-guiding member 203 and two or more of the wall sides. According to requirement, all of the side walls with the light source 202 and without the light source 202 may choose whether to be provided with the avoidance gap c or not. The avoidance gap c may be formed on all of the side walls, and may also be formed on a part of the side walls.

In an embodiment, as shown in FIG. 3, a width Lc of the avoidance gap c is greater than a width Lm of the optical film 204, which ensures that the optical film 204 is successfully expanded into the avoidance gap c and may not collide with the side walls 2012 when the optical film 204 is expanded to enter the avoidance gap c.

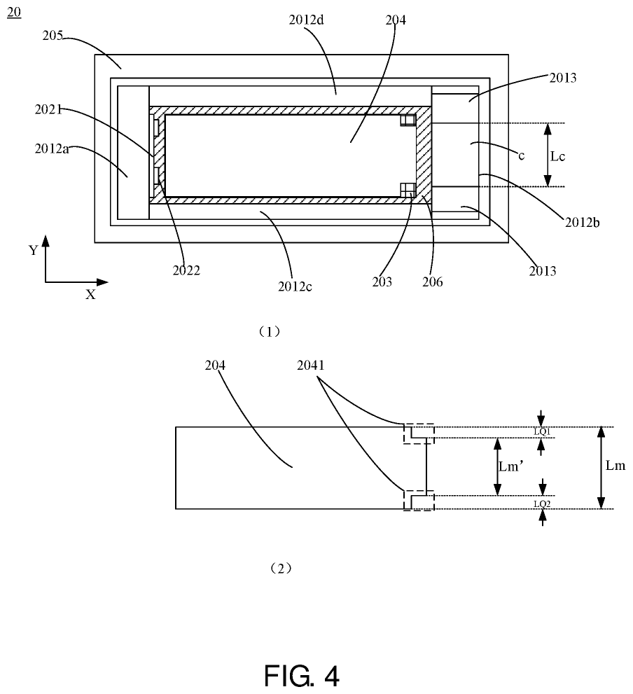

In an embodiment, as shown in (1) of FIG. 4, when the width Lc of the avoidance gap c is less than the width Lm of the optical film, in order to prevent the avoidance gap c from being impeded, as shown in (2) of FIG. 4, the optical film 204 is provided with film gaps 2041 at regions corresponding to the supporting protrusions 2013, and the difference Lm′ between the width Lm of the optical film and a total width (LQ1+LQ2) of the film gaps 2041 is less than the width Lc of the avoidance gap. Therefore, when the optical film 204 is expanded, because the optical film 204 is provided with the film gaps 2041 corresponding to the supporting protrusions 2013, the supporting protrusions 2013 at both sides of the avoidance gap c do not impede the expansion of the optical film 204, thus ensuring that a part of the optical film 204 provided with the film gaps 2041 is successfully expanded into the avoidance gap c and may not collide with the side walls 2012, and thereby the optical film 204 may not be wrinkled due to the expansion not being impeded.

In an embodiment, in order to prevent the gaps 2041 of the optical film 204 from affecting backlight quality, projection of the gaps 2041 on the bottom plate 2011 is covered by projection of the fixed frame 205 on the bottom plate 2011.

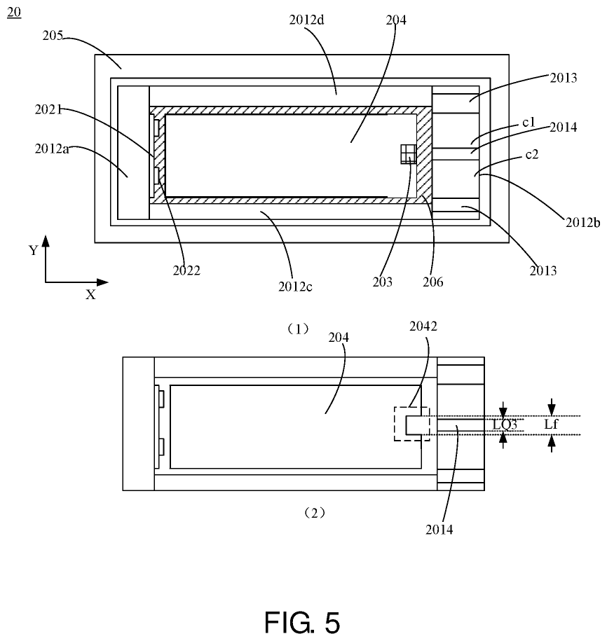

In an embodiment, as shown in (1) of FIG. 5, based on the embodiments shown in FIG. 2, in order to enhance fixed stability between the fixed frame 205 and the side walls 2013, the side walls 2013 further include an auxiliary supporting protrusion 2014. In this condition, the auxiliary supporting protrusion 2014 divides the avoidance gap c into two or more sub-avoidance gaps, i.e., the sub-avoidance gap c1 and the sub-avoidance gap c2 shown in (1) of FIG. 5. In order to prevent the auxiliary supporting protrusion 2014 from impeding the optical film 204, as shown in (2) of FIG. 5, the optical film 204 needs to be cut in a region corresponding to the auxiliary supporting protrusion 2014 to form an auxiliary film gap 2042 at the corresponding region. In this condition, a width LQ3 of the auxiliary film gap 2042 is greater than a width Lf of the auxiliary supporting protrusion 2014. Therefore, when the optical film 204 is expanded, because the optical film 204 is provided with the auxiliary film gap 2042 corresponding to the auxiliary supporting protrusion 2014, the auxiliary supporting protrusion 2014 within the avoidance gap c does not impede the expansion of the optical film 204, thus ensuring that a part of the optical film 204 provided with the auxiliary film gap 2042 is successfully be expanded into the avoidance gap c and may not collide with the auxiliary supporting protrusion 2014 on the side wall 2012, and thereby the optical film 204 may not be wrinkled due to the expansion not being impeded.

In an embodiment, as shown in FIG. 6 and FIG. 7, the avoidance gap c is shaped as a recess. A shape of the recess may be at least one of a rectangular rectangle lacking one side, a rounded rectangle, a semicircle, a trapezoid, and a triangle, but the shape of the avoidance gap c is not limit to the above-mentioned shapes and may also be other shapes. As long as the optical film 204 does not contact with the side walls when expanded, the shape of the optical film 204 may be designed according to requirements.

In an embodiment, as shown in FIG. 6, the bottom surface 2051 of the fixed frame 205 is a plane, and the fixed frame 205 is directly fixed on the supporting protrusions 2013. Due to being easily achieved, this method is not described in detail.

In an embodiment, as shown in FIG. 7, the bottom surface 2051 of the fixed frame 205 is provide with fixed gaps 2052. The fixed frame 205 is fixed on the side walls 2012 by the fixed gaps 2052 and the supporting protrusions 2013.

In an embodiment, a cross-sectional shape of the fixed gaps 2052 is at least one of a rectangle, a trapezoid, or a semicircle.

In an embodiment, a shape of the supporting protrusions 2013 is the same as the shape of the fixed gaps 2052. The cross-sectional shape of both may be at least one of the rectangle, the trapezoid, or the semicircle, or other shapes.

In an embodiment, the shape of the supporting protrusions 2013 is different from the shape of the fixed gaps 2052. For example, the shape of the supporting protrusions 2013 is the rectangle, and the shape of the fixed gaps 2052 is the semicircle. The shapes of the supporting protrusions 2013 and the fixed gaps 2052 may be designed according to requirements.

In an embodiment, as shown in FIG. 7, a height h1 of the supporting protrusions 2013 is greater than or equal to a depth h2 of the fixed gaps 2052, thus ensuring that the supporting protrusions 2013 are completely extend into the fixed gaps 2052, and support the fixed frame and a backlight space in a vertical direction Z.

In an embodiment, as shown in FIG. 7, the difference h1-h2 between the height h1 of the supporting protrusions 2013 and the depth h2 of the fixed gaps 2052 is equal to the height H of the avoidance gap c to allow the fixed frame 205 is stably disposed on the side walls 2012.

In an embodiment, the side walls 2012 are formed first, and then a part of a middle region of the side wall 2012b is cut downward along the vertical direction Z and is removed to form the avoidance gap c, and a remaining uncut part serves as the supporting protrusions 2013. The side walls 2012 may also be formed to include the avoidance gap c and the supporting protrusions 2013 directly.

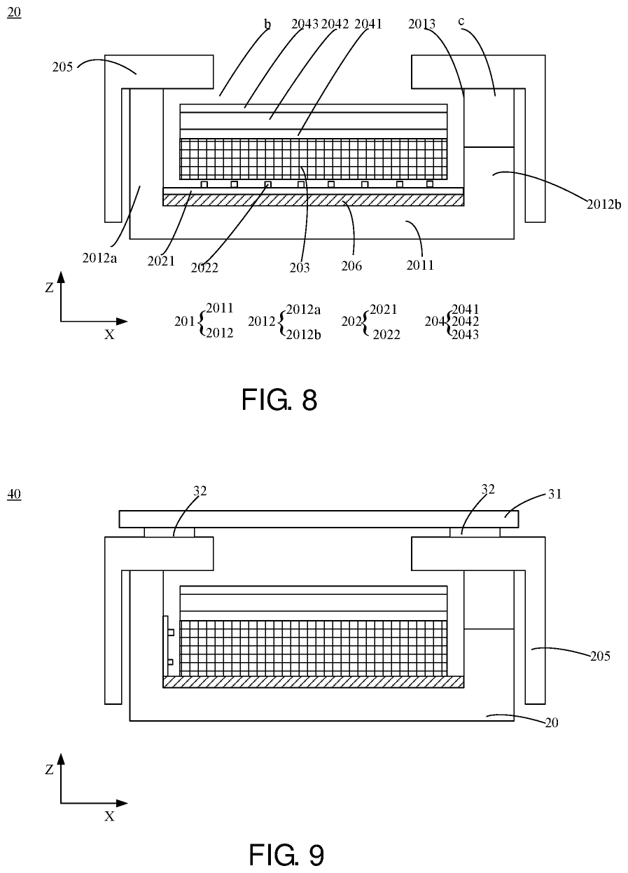

In an embodiment, as shown in FIG. 8, the backlight module 20 is a direct-type backlight module. The light source 202 is disposed between the light-guiding member 203 and the bottom plate of the bottom plate 2011. Furthermore, the refection sheet 206 is disposed between the light source 203 and the bottom plate 2011. The light source 202 emits the light from bottom to top. The light-in surface of the light-guiding member 203 corresponds to the light-out surface of the light source.

In this embodiment, the light-guiding member 203 is a diffusion plate. The diffusion plate adequately scatters incident light emitted by the light source 202, and has a desirable shielding effect on light shadow, thereby realizing the soft and uniform light source.

In an embodiment, as shown in FIG. 8, the side wall 2012a and the side wall 2012b form the avoidance gap c. When the optical film 204 is thermally expanded, the side walls 2012 based on the avoidance gap c does not impede the optical film 204, so that the optical film 204 does not generate the wrinkles, thereby preventing causing the poor optical performance. Certainly, the avoidance gap c may also be formed on only one of the side walls 2012, or the avoidance gap c may be formed on any two or more of the side walls 2012.

In an embodiment, the present disclosure further provides a liquid crystal module, and the liquid crystal module includes a backlight module provided by the embodiments of the present disclosure and a liquid crystal display panel. The liquid crystal display panel is fixed on the fixed frame of the backlight module.

In an embodiment, when the liquid crystal module does not support a touching function, or a touching function layer is integrated in the liquid crystal display panel, as shown in FIG. 9, the liquid crystal module 40 provided by the embodiment of the present disclosure includes:

a backlight module 20 including a back plate 201, a light source 202, a light-guiding plate 203, an optical film 204, and a fixed frame 205, wherein the back plate 201 includes a bottom plate 2011 and side walls 2012, and the bottom plate 2011 and the side walls 2012 form a receiving cavity b; the light source 202, the light-guiding plate 203, and the optical film 204 are disposed within the receiving cavity, a light-out surface of the light source 202 corresponds to a light-in surface of the light-guiding member 203, and the optical film 204 is located on the light-out surface of the light-guiding member 203; the fixed frame 205 is disposed on the back plate 201; and

a liquid crystal display panel 31 fixed on the fixed frame 205;

wherein at least one of the side walls 2012 is provided with an avoidance gap c and supporting protrusions 2013 located at both sides of the avoidance gap c, a disposed location of the avoidance gap c corresponds to a site of the optical film 204, a height H of the avoidance gap c is greater than or equal to a thickness d of the optical film 204, and the fixed frame 205 are disposed on the supporting protrusions 2013.

The embodiment provides a liquid crystal module. At least one of the side walls of the backlight module of the liquid crystal module is provided with the avoidance gap at the location corresponding to the optical film, and the height of the avoidance gap is greater than or equal to the thickness of the optical film. The side wall provided with the avoidance gap is further provided with the supporting protrusions at both sides of the avoidance gap, and the fixed frame is disposed on the supporting protrusions. In the embodiment, by disposing the avoidance gap at the location of the side wall corresponding to the optical film, when the optical film is thermally expanded, the deformed optical film is located within the avoidance gap, so the side wall does not impede the expansion of the optical film, such that the optical film does not generate wrinkles caused by the expansion being impeded.

The liquid crystal display panel 31 is fixed on the fixed frame 205 of the backlight module by an adhesive layer 32. Material of the adhesive layer 32 is generally double-sided tape or foam.

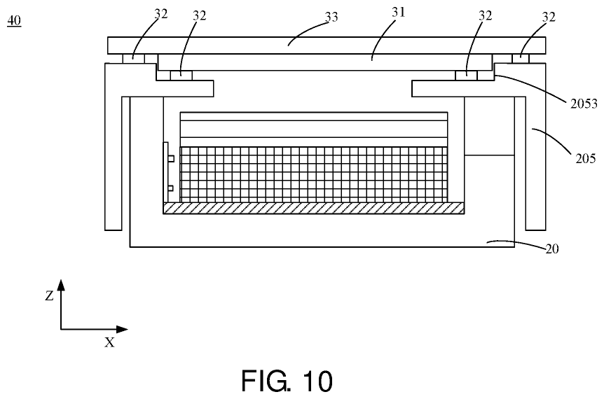

In an embodiment, when the liquid crystal module supports the touching function, and a touching function layer is not integrated in the liquid crystal display panel, as shown in FIG. 10, the liquid crystal module 40 provided by the embodiment of the present disclosure further includes: a touch panel 33 fixed on the fixed frame 205.

In the embodiment, a cross-section of a top surface 2053 of the fixed frame 205 is stepped shape. The liquid crystal display panel 31 and the touch panel 33 are respectively fixed on the different step of the fixed frame 205 of the backlight module by the adhesive layer 32. The material of the adhesive layer 32 is generally double-sided tape or foam. A bonding material (not shown) is disposed between the liquid crystal display panel 31 and the touch panel 33. The bonding material is generally optical clear adhesive.

In an embodiment, in the liquid crystal module provided by the embodiments of the present disclosure, a width of the avoidance gap is greater than a width of the optical film.

In an embodiment, in the liquid crystal module provided by the embodiments of the present disclosure, the width of the avoidance gap is less than the width of the optical film, the optical film is provided with the avoidance gap at a region corresponding to the supporting protrusions.

In an embodiment, in the liquid crystal module provided by the embodiments of the present disclosure, the light source is disposed between the light-guiding plate and at least one of the side walls, or the light source is disposed between the light-guiding plate and the bottom plate.

In an embodiment, in the liquid crystal module provided by the embodiments of the present disclosure, the avoidance gap is shaped as a recess.

In an embodiment, in the liquid crystal module provided by the embodiments of the present disclosure, the backlight module 20 further includes a reflection sheet 206. The reflection sheet is disposed within the receiving cavity and located between the light-guiding member and the bottom plate.

In the liquid crystal module provided by the embodiments of the present disclosure, the fixed frame includes at least one of a plastic frame, a cast aluminum part, or a sheet metal frame.

In an embodiment, in the liquid crystal module provided by the embodiments of the present disclosure, a bottom surface of the fixed frame is provided with fixed gaps, and the fixed frame is fixed on the side walls by the fixed gaps and the supporting protrusions.

In an embodiment, in the liquid crystal module provided by the embodiments of the present disclosure, a cross-sectional shape of the fixed gaps is at least one of a rectangle, a trapezoid, or a semicircle.

In an embodiment, in the liquid crystal module provided by the embodiments of the present disclosure, a height of the supporting protrusions is greater than or equal to a depth of the fixed gaps.

Furthermore, the present disclosure also provides an in-vehicle display device with a narrow frame. The in-vehicle display device with the narrow frame includes a liquid crystal module provided by the embodiments of the disclosure.

The embodiment provides an in-vehicle display device with a narrow frame. At least one of side walls of a backlight module of the liquid crystal module is provided with an avoidance gap at a location corresponding to an optical film. In the embodiment, by disposing the avoidance gap at the location of the side wall corresponding to the optical film, when the optical film is thermally expanded, the deformed optical film is located within the avoidance gap, so the side wall does not impede the expansion of the optical film, such that the optical film dost not generate wrinkles caused by the expansion being impeded, thereby ameliorating the technical problem about the expansion of the optical films being impeded, which is existed in the conventional backlight modules used in the in-vehicle display devices with the narrow frames, enhancing display stability of the in-vehicle display devices with the narrow frames, and improving users' experiences.

According to the above-mentioned embodiments, it may be known that:

The present disclosure provides a backlight module and a liquid crystal module. The backlight module includes the back plate, the light source, the light-guiding member, the optical film, and the fixed frame. The back plate includes the bottom plate and the side walls, and the bottom plate and the side walls form the receiving cavity. The light source is disposed within the receiving cavity, the light-guiding member is disposed within the receiving cavity, and the light-out surface of the light source corresponds to the light-in surface of the light-guiding member. The optical film is disposed within the receiving cavity and located on the light-out surface of the light-guiding member. The fixed frame is disposed on the back plate. At least one of the side walls is provided with the avoidance gap at the location corresponding to the optical film, and the height of the avoidance gap is greater than or equal to the thickness of the optical film. In the present disclosure, by disposing the avoidance gap at the location of the side wall corresponding to the optical film, when the optical film is thermally expanded, the deformed optical film is located within the avoidance gap, so the side wall does not impede the expansion of the optical film, such that the optical film does not generate wrinkles caused by the expansion being impeded, thereby ameliorating the technical problem about the expansion of the optical films being impeded, which is existed in the conventional backlight modules used in the in-vehicle display devices with the narrow frames, enhancing the display stability of the in-vehicle display devices with the narrow frames, and improving the users' experiences.

In summary, although the present disclosure has been disclosed with above preferred embodiments, the above preferred embodiments don't intend to limit the present disclosure, and those skilled in the art may make various changes and modifications without departing from the spirit and the scope of the present disclosure. Therefore, the protection scope of the present disclosure is defined by the scope of the claims.

What is claimed is:

1. A backlight module, comprising:
a back plate including a bottom plate and side walls, wherein the bottom plate and the side walls form a receiving cavity;
a light source disposed within the receiving cavity;
a light-guiding member disposed within the receiving cavity, wherein a light-out surface of the light source corresponds to a light-in surface of the light-guiding member;
an optical film disposed within the receiving cavity and located on the light-out surface of the light-guiding member; and
a fixed frame disposed on the side walls;
wherein at least one of the side walls is provided with an avoidance gap and supporting protrusions located at both sides of the avoidance gap, a disposed location of the avoidance gap corresponds to a site of the optical film, a height of the avoidance gap is greater than or equal to a thickness of the optical film, and the fixed frame are disposed on the supporting protrusions.

2. The backlight module according to claim 1, wherein a width of the avoidance gap is greater than a width of the optical film.

3. The backlight module according to claim 1, wherein a width of the avoidance gap is less than a width of the optical film, the optical film is provided with film gaps at regions corresponding to the supporting protrusions, and the difference between the width of the optical film and a total width of the film gaps is less than the width of the avoidance gap.

4. The backlight module according to claim 1, wherein the light source is disposed between the light-guiding plate and at least one of the side walls, or the light source is disposed between the light-guiding plate and the bottom plate.

5. The backlight module according to claim 1, wherein the avoidance gap is shaped as a recess.

6. The backlight module according to claim 1, wherein the backlight module further comprises a reflection sheet disposed within the receiving cavity and located between the light-guiding member and the bottom plate.

7. The backlight module according to claim 1, wherein the fixed frame includes at least one of a plastic frame, a cast aluminum part, or a sheet metal frame.

8. The backlight module according to claim 1, wherein a bottom surface of the fixed frame is provided with fixed gaps, and the fixed frame is fixed on the side walls by the fixed gaps and the supporting protrusions.

9. The backlight module according to claim 8, wherein a cross-sectional shape of the fixed gaps is at least one of a rectangle, a trapezoid, or a semicircle.

10. The backlight module according to claim 8, wherein a height of the supporting protrusions is greater than or equal to a depth of the fixed gaps.

11. A liquid crystal module, comprising:
a backlight module including a back plate, a light source, a light-guiding plate, an optical film, and a fixed frame, wherein the back plate includes a bottom plate and side walls, and the bottom plate and the side walls form a receiving cavity; the light source, the light-guiding plate, and the optical film are disposed within the receiving cavity, a light-out surface of the light source corresponds to a light-in surface of the light-guiding plate, and the optical film is located on the light-out surface of the light-guiding plate; the fixed frame is disposed on the back plate; and
a liquid crystal display panel fixed on the fixed frame;
wherein at least one of the side walls is provided with an avoidance gap and supporting protrusions located at both sides of the avoidance gap, a disposed location of the avoidance gap corresponds to a site of the optical film, a height of the avoidance gap is greater than or equal to a thickness of the optical film, and the fixed frame are disposed on the supporting protrusions.

12. The liquid crystal module according to claim 11, wherein the liquid crystal module further includes a touch panel fixed on the fixed frame.

13. The liquid crystal module according to claim 11, wherein a width of the avoidance gap is greater than a width of the optical film, or the width of the avoidance gap is less than the width of the optical film; the optical film is provided with film gaps at regions corresponding to the supporting protrusions, and the difference between the width of the optical film and a total width of the film gaps is less than the width of the avoidance gap.

14. The liquid crystal module according to claim 11, wherein the light source is disposed between the light-guiding plate and at least one of the side walls, or the light source is disposed between the light-guiding plate and the bottom plate.

15. The liquid crystal module according to claim 11, wherein the avoidance gap is shaped as a recess.

16. The liquid crystal module according to claim 11, wherein the liquid crystal module further comprises a reflection sheet disposed within the receiving cavity and located between the light-guiding member and the bottom plate.

17. The liquid crystal module according to claim 11, wherein the fixed frame includes at least one of a plastic frame, a cast aluminum part, or a sheet metal frame.

18. The liquid crystal module according to claim 11, wherein a bottom surface of the fixed frame is provided with fixed gaps, and the fixed frame is fixed on the side walls by the fixed gaps and the supporting protrusions.

19. The liquid crystal module according to claim 11, wherein a cross-sectional shape of the fixed gaps is at least one of a rectangle, a trapezoid, or a semicircle.

20. The liquid crystal module according to claim 11, wherein a height of the supporting protrusions is greater than or equal to a depth of the fixed gaps.
